(19) United States
(12) Patent Application Publication
(10) Pub. No.: US 2008/0161473 A1
(43) Pub. Date: Jul. 3, 2008

(54) Hybrid composition and films fabricated by the same

(75) Inventors: Chyi-ming Leu, Taichung County (TW); Hang-chang Chang, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/812,940

(22) Filed: Jun. 22, 2007

(30) Foreign Application Priority Data
Dec. 29, 2006 (TW) 95149922

(51) Int. Cl. C08K 3/34

(52) U.S. Cl. 524/442

(57) ABSTRACT

A hybrid composition and films fabricated by the same are provided. The film fabricated by the hybrid composition exhibits high transparency, high thermal-resistance, and low coefficient of thermal expansion. The hybrid composition of the invention comprises silicon oxide and polyimide uniformly mixed, wherein the weight ratio between silicon oxide and polyimide is 1:9 to 9:1.

### BACKGROUND OF THE INVENTION

1. Field of the Invention

The invention relates to a hybrid composition and films fabricated by the same, and more particularly to a SiO₂/polyimide hybrid composition and films fabricated by the same.

2. Description of the Related Art

To achieve flatness, transparency, and high fabrication temperature tolerance, glass is a common choice for substrates. Current trends move toward light weight, slim profile, and even display on non-flat surfaces. Therefore, soft and flexible displays are currently being developed to replace glass substrates.

To achieve the above objects, flexible plastic (polymer) substrates have been developed for flat panel display, such as polycarbonate (PC), polyethylene terephthalate (PET) and polyimide, but these polymer substrates have disadvantages.

Polymer temperature tolerance is too low for fabrication, with maximum PC temperature about 129° C. and PE about 120° C. As well, polymers exhibit poor resistance to heat and humidity, and have high coefficient of thermal expansion. Moreover, PC and PET plastic substrates have difficulty achieving optical flatness and cannot be polished by chemical mechanical polishing. Thus, in conventional technology, soft and flexible plastic substrate cannot replace glass.

JP Patent 2005-187768 assigned to TAKASHI (“METHOD FOR PRODUCING POLYIMIDE/INORGANIC COMPOSITE MATERIAL”) discloses a composite material with high thermal-resistance and low coefficient of thermal expansion comprising polyimide and inorganic compound.

The method for producing a polyimide/inorganic composite material comprises reacting a semi-aliphatic and/or complete aliphatic polyimide, soluble in an organic solvent having a repeated unit represented by a specific chemical structural formula, with a silane coupling agent having reactivity with the terminal groups of the polyimide, and then adding silicon alkoxide and distilled water to conduct a sol-gel reaction. The inorganic compound weight ratio of the composite material, however, cannot be more than 20%, due to silicon oxide and water use as reactants.

To raise the inorganic compound weight ratio to enhance the properties of the flexible film, a PAA(polyamic acid)/silicic acid oligomer hybrid film is provided. The inorganic compound weight ratio of the hybrid film can achieve 40%, but the hybrid film exhibits yellow color and has poor transparency.

Therefore, it is necessary to develop a flexible transparent substrate with high transparency, high thermal-resistance, and low coefficient of thermal expansion for flat panel display.

### BRIEF SUMMARY OF THE INVENTION

An exemplary embodiment a hybrid composition comprises silicon oxide and polyimide uniformly mixed, wherein the weight ratio between silicon oxide and polyimide is 1:9 to 9:1.

Methods for preparing the hybrid composition are also provided. In an exemplary embodiment of such a method, silicon oxide is dissolved in an organic solvent with a solid content less than 40%. A polyimide solution is added into the silicon oxide solution, wherein the weight ratio between silicon oxide and polyimide is 1:9 to 9:1, preferably 2:8 to 9:1. After stirring completely, a siloxane surfactant with polar functional groups is added into the mixture.

A flexible transparent film prepared by the hybrid composition is provided. The flexible transparent film silicon oxide and polyimide, wherein the weight ratio between silicon oxide and polyimide is 1:9 to 9:1.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a graphical representation of films prepared by Example 5 and Comparative Example 1 via thermal gravimetric analysis.

FIGS. 2 to 4 are transmission electron microscope (TEM) photographs showing the dispersive morphology of the hybrid film (SiO₂/BB64) prepared by Example 5 with different image sizes.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

An embedment of the invention provides a silicon oxide/polyimide hybrid material with high transparency, high thermal-resistance, and low coefficient of thermal expansion, serving as the support substrates of flexible flat panel displays. Another embedment of the invention provides a hybrid composition with modifiable weight ratio between silicon oxide and polyimide uniformly dissolved in an organic. The hybrid composition is prepared by, first, dissolving silicon oxide in an organic to obtain micro-structure silicon oxide. Next, the result is mixed with polyimide optionally employed a siloxane surfactant as an additive. Therefore, the silicon oxide weight ratio of the hybrid composition can be increased, thereby enhancing the transparency more than 90%, glass transition temperature more than 350° C., and reducing the coefficient of thermal expansion less than 30 ppm/° C. in products made from the hybrid composition.

The method for preparing the hybrid composition comprises dissolving silicon oxide in an organic solvent with a solid content less than 40%. Next, a polyimide solution is added into the silicon oxide solution, wherein the weight ratio between silicon oxide and polyimide is 1:9 to 9:1, preferably 2:8 to 9:1. After stirring completely, a siloxane surfactant with polar functional groups is added into the mixture.

The organic solvent can be DMAC, DMF, DMSO, r-butyrolactone, or combinations thereof. The siloxane surfactant with polar functional groups can be aminosiloxane, isocynate silane, or combinations thereof. The polyimide can have the structures represented by formula (I), wherein n is more than 1; G is cycloalkyl group, heterocycloalkyl group, saturated or unsaturated cycloalkyl group, saturated or unsaturated heterocycloalkyl group, aryl group, heteroaryl group, arylalkyl group, alkylaryl group, heteroalkylaryl group or combinations thereof, and has 3 to 8 carbon atoms; and A is cycloalkyl group, heterocycloalkyl group, saturated or unsaturated cycloalkyl group, saturated or unsaturated heterocycloalkyl group, aryl group, heteroaryl group, arylalkyl group, alkylaryl group, or heteroalkylaryl group, and has 3 to 8 carbon atoms.

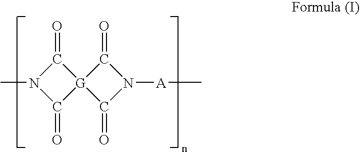

Further, G can be

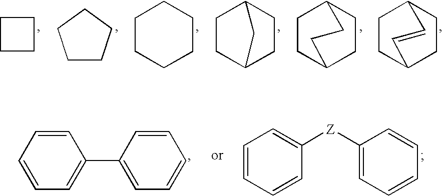

Z can be —O—, —CH₂—, —C(CH₃)₂—, —Ar—O—Ar—, Ar—CH₂—Ar—, —Ar—C(CH₃)₂—Ar—, or —Ar—SO₂—Ar—; and Ar can be benzene. A can be

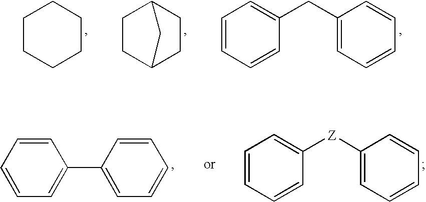

z can be —O—, —CH₂—, —C(CH₃)₂—, —Ar—O—Ar—, Ar—CH₂—Ar—, —Ar—C(CH₃)₂—Ar—, or —Ar—SO₂—Ar—; and Ar can be berzene. Moreover, at least one hydrogen atom bonded to the carbon atom of G can be substituted optionally by fluorine atom, halogen atom, cyano group, thioalkyl group, alkyl group, alkoxy group, aryl group, or alkylaryl group, and at least one hydrogen atom bonded to the carbon atom of A can be substituted optionally by fluorine atom, halogen atom, cyano group, thioalkyl group, alkyl group, alkoxy group, aryl group, or alkylaryl group.

Two polycondensation methods have been employed to prepare polyimide. In the first method, the polyimide is prepared by, first, reacting a diamine monomer with a dianhydride monomer in a polar solvent to prepare a precursor-poly amic acid (PAA). Next, the precursor is subjected to a thermal or chemical treatment to undergo an imidization. In another method, a diamine monomer is reacted with a dianhydride monomer in a phenolic solution such as m-cresol, or Cl-phenol and heated to reflux.

The following examples and comparative examples are intended to demonstrate this invention more fully without limiting its scope, since numerous modifications and variations will be apparent to those skilled in the art.

### Preparation of Polyimide

### EXAMPLE 1

0.0147 mole of BAPPm

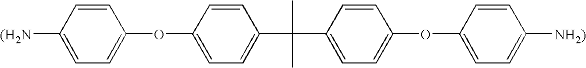

was dissolved in 32.94 g of m-cresol. After stirring, 0.015 mole of B1317

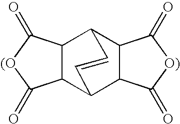

was added, and a stringy mixture was obtained after stirring for one hour. Next, the result was heated to 220° C. for 3 hours and ground water was removed during heating. After purification and drying, the polyimide (B1317-BAPPm (BB)) was obtained. The reaction according to Example 1 is shown below.

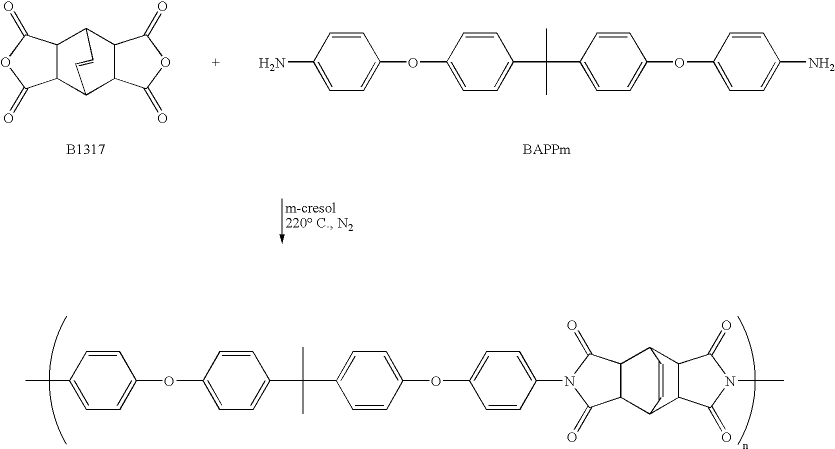

### Preparation of Silicon Oxide/Polyimide Hybrid Film

### EXAMPLE 2

At room temperature, 3 g of silicon oxide was dissolved in the DMAc with a solid content of 20% preparing a silicon oxide solution. Next, 7 g of B1317-BAPPm dissolved in the DMAc with a solid content of 20% was added to the silicon oxide solution. Next, 0.3 g of aminosiloxane was added into the mixture. After stirring for 30 min, the composition was coated on a glass substrate and heated at 80° C. for one hour and 150° C. for one hour respectively, obtaining a hybrid film (SiO₂/BB37) with a thickness of 53.7 μm. The weight ratio between the silicon oxide and the polyimide was 3:7. The measured results of transparency and coefficient of thermal expansion for the hybrid film (SiO₂/BB37), as described in Example 2, are shown in Table 1.

### EXAMPLE 3

At room temperature, 4 g of silicon oxide was dissolved in the DMAc with a solid content of 20% preparing a silicon oxide solution. Next, 6 g of B1317-BAPPm dissolved in the DMAc with a solid content of 20% was added into the silicon oxide solution. Next, 0.2 g of aminosiloxane was added into the mixture. After stirring for 30 min, the composition was coated on a glass substrate and heated at 80° C. for one hour and 150° C. for one hour respectively, obtaining a hybrid film (SiO₂/BB46) with a thickness of 55 μm. The weight ratio between the silicon oxide and the polyimide was 4:6. The measured results of transparency and coefficient of thermal expansion for the hybrid film (SiO₂/BB46), as described in Example 3, are shown in Table 1.

### EXAMPLE 4

At room temperature, 5 g of silicon oxide was dissolved in the DMAc with a solid content of 20% preparing a silicon oxide solution. Next, 5 g of B1317-BAPPm dissolved in the DMAc with a solid content of 20% was added into the silicon oxide solution. Next, 0.2 g of aminosiloxane was added into the mixture. After stirring for 30 min, the composition was coated on a glass substrate and heated at 80° C for one hour and 150° C. for one hour respectively, obtaining a hybrid film (SiO₂/BB55) with a thickness of 52 μm. The weight ratio between the silicon oxide and the polyimide was 5:5. The measured results of transparency and coefficient of thermal expansion for the hybrid film (SiO₂/BB55), as described in Example 4, are shown in Table 1.

### EXAMPLE 5

At room temperature, 6 g of silicon oxide was dissolved in the DMAc with a solid content of 20% preparing a silicon oxide solution. Next, 4 g of B1317-BAPPm dissolved in the DMAc with a solid content of 20% was added into the silicon oxide solution. Next, 0.2 g of aminosiloxane was added into the mixture. After stirring for 30 min, the composition was coated on a glass substrate and heated at 80° C. for one hour and 150° C. for one hour respectively, obtaining a hybrid film (SiO₂/BB64) with a thickness of 53 μm. The weight ratio between the silicon oxide and the polyimide was 6:4. The measured results of transparency and coefficient of thermal expansion for the hybrid film (SiO₂/BB64), as described in Example 5, are shown in Table 1.

### EXAMPLE 6

At room temperature, 7 g of silicon oxide was dissolved in the DMAc with a solid content of 20% preparing a silicon oxide solution. Next, 3 g of B1317-BAPPm dissolved in the DMAc with a solid content of 20% was added into the silicon oxide solution. Next, 0.12 g of aminosiloxane was added into the mixture. After stirring for 30 min, the composition was coated on a glass substrate and heated at 80° C. for one hour and 150° C. for one hour respectively, obtaining a hybrid film (SiO₂/BB73) with a thickness of 51 μm. The weight ratio between the silicon oxide and the polyimide was 7:3. The measured results of transparency and coefficient of thermal expansion for the hybrid film (SiO₂/BB73), as described in Example 6, are shown in Table 1.

### Comparative Example 1

At room temperature, 10 g of B1317-BAPPm was dissolved in the DMAc with a solid content of 20%. After stirring, the composition was coated on a glass substrate and heated at 80° C. for one hour and 150° C. for one hour respectively, obtaining a film with a thickness of 57 μm. The measured results of transparency and coefficient of thermal expansion for the film, as described in Comparative Example 1, are shown in Table 1.

TABLE 1

| | SiO₂/polyimide | thickness (μm) | CTE (ppm/° C.) | T (%) |
|---|---|---|---|---|
| Comparative | 0/100 | 57 | 75.4 | 89.3 |
| Example 1 | | | | |
| Example 2 | 30/70 | 53 | 56.6 | 89.5 |
| Example 3 | 40/60 | 55 | 52.3 | 89.3 |
| Example 4 | 50/50 | 52 | 48.6 | 89.6 |
| Example 5 | 60/40 | 53 | 42.6 | 89.3 |
| Example 6 | 70/30 | 51 | 28.3 | 90.1 |

As shown in Table 1, the coefficient of thermal expansion is reduced when increasing the weight ratio of silicon oxide. Particularly, the hybrid film (SiO₂/BB37) has a coefficient of thermal expansion less than 30 ppm/° C., and the hybrid film has excellent transparency even though the weight ratio of silicon oxide approaches 70%.

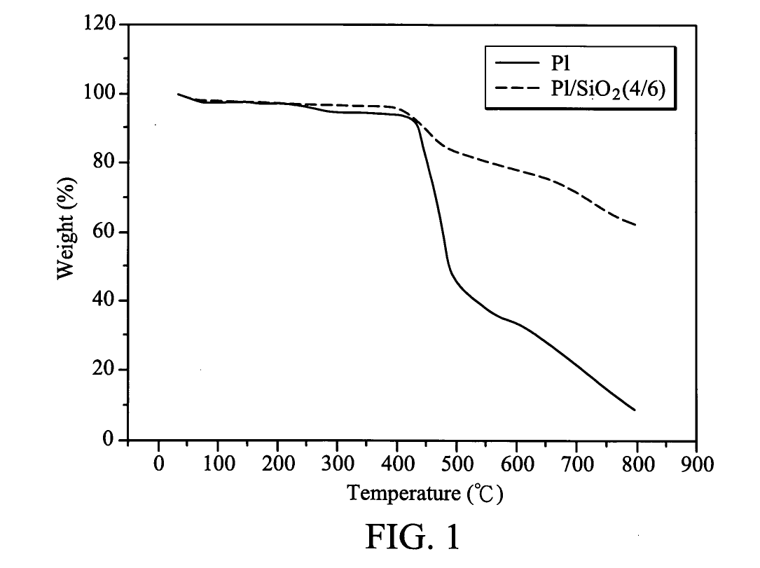

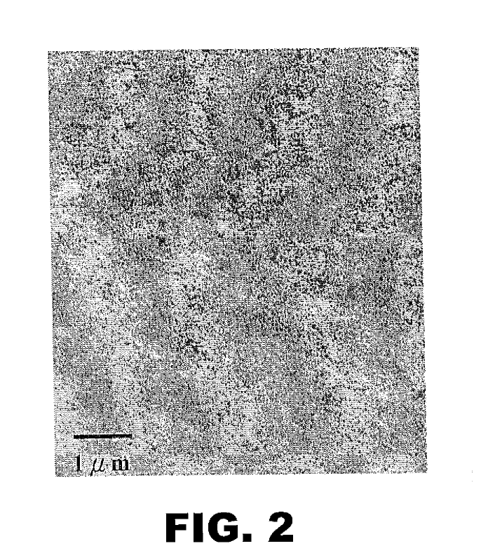

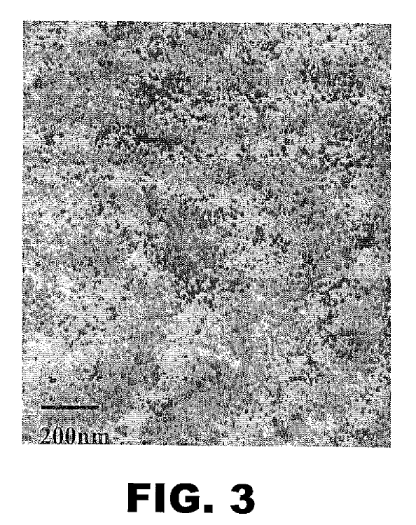

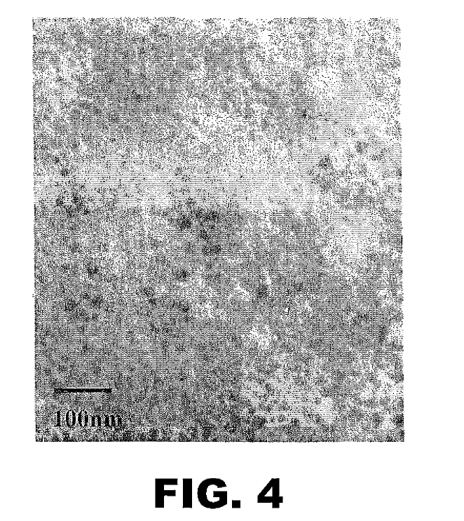

The hybrid film (SiO₂/BB64) prepared by Example 5 and the film prepared by Comparative Example 1 were characterized by thermal gravimetric analysis (TGA), and the result is shown in FIG. 1. The hybrid film (SiO₂/BB64) prepared by Example 5 has a better thermal-resistance than the film prepared by Comparative Example 1. FIGS. 2 to 4 are transmission electron microscope (TEM) photographs showing the dispersive morphology of the hybrid film (SiO₂/BB64) prepared by Example 5 with different Image sizes.

The measured results of mechanical strength for the films prepared by Example 5 and Comparative Example 1, are shown in Table 2.

TABLE 2

| | | Young's | | tension |
|---|---|---|---|---|
| | SiO₂/polyimide | module (Gpa) | stress (Mpa) | (%) |
| Comparative | 0/100 | 0.68 | 61 | 9.2 |
| Example 1 | | | | |
| Example 5 | 60/40 | 2.46 | 92 | 3.8 |

As shown in Table 2, the hybrid film (SiO₂/BB64) prepared by Example 5 exhibits superior mechanical strength, and can serve as support substrate of flat panel display.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hybrid composition, comprising silicon oxide and polyimide uniformly mixed, wherein the weight ratio between silicon oxide and polyimide is 1:9 to 9:1.

2. The composition as claimed in claim 1, wherein the weight ratio between silicon oxide and polyimide is 2:8 to 9:1.

3. The composition as claimed in claim 1, further comprising a siloxane surfactant.

4. The composition as claimed in claim 3, wherein the siloxane surfactant has polar functional groups.

5. The composition as claimed in claim 3, wherein the siloxane surfactant is aminosiloxane.

6. The composition as claimed in claim 1, wherein the silicone oxide dissolves in an organic solvent with a solid content less than 40%.

7. The composition as claimed in claim 1, wherein the polyimide has the structures represented by formula (I), of 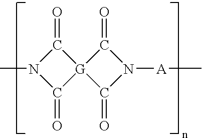
wherein
n is more than 1;
G is cycloalkyl group, heterocycloalkyl group, saturated or unsaturated cycloalkyl group, saturated or unsaturated heterocycloalkyl group, aryl group, heteroaryl group, arylalkyl group, alkylaryl group, heteroalkylaryl group or combinations thereof, and has 3 to 8 carbon atoms; and
A is cycloalkyl group, heterocycloalkyl group, saturated or unsaturated cycloalkyl group, saturated or unsaturated heterocycloalkyl group, aryl group, heteroaryl group, arylalkyl group, alkylaryl group, or heteroalkylaryl group, and has 3 to 8 carbon atoms.

8. The composition as claimed in claim 7, wherein G comprises 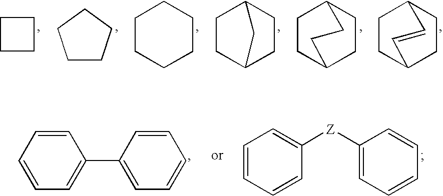
Z is —O—, —CH₂—, —C(CH₃)₂—, —Ar—O—Ar—, Ar—CH₂—Ar—, —Ar—C(CH₃)₂—Ar—, or —Ar—SO₂—Ar—; and Ar is benzene.

9. The composition as claimed in claim 7, wherein at least one hydrogen atom bonded to the carbon atom of G is substituted optionally by fluorine atom, halogen atom, cyano group, thioalkyl group, alkyl group, alkoxy group, aryl group, or alkylaryl group.

10. The composition as claimed in claim 7, wherein A comprises 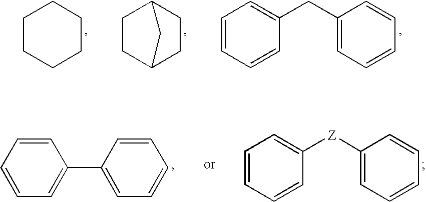
comprises —O—, —CH₂—, —C(CH₃)₂—, —Ar—O—Ar—, Ar—CH₂—Ar—, —Ar—C(CH₃)₂—Ar—, or —Ar—SO₂—Ar—; and Ar is berzene.

11. The composition as claimed in claim 7, wherein at least one hydrogen atom bonded to the carbon atom of A is substituted optionally by fluorine atom, halogen atom, cyano group, thioalkyl group, alkyl group, alkoxy group, aryl group, or alkylaryl group.

12. A flexible transparent film, comprising silicon oxide and polyimide uniformly mixed, wherein the weight ratio between silicon oxide and polyimide is 1:9 to 9:1.

13. The flexible transparent film as claimed in claim 12, wherein the flexible transparent film is a part of a display device.

14. The flexible transparent film as claimed in claim 13, wherein a flat panel display has the flexible transparent film as a transparent substrate.

15. The flexible transparent film as claimed in claim 13, wherein the flexible transparent film is an optical film of a display device.

16. The flexible transparent film as claimed in claim 12, wherein the flexible transparent film is a part of an optoelectronic device.

17. The flexible transparent film as claimed in claim 12, wherein the weight ratio between silicon oxide and polyimide is 2:8 to 9:1.

18. The flexible transparent film as claimed in claim 12, further comprising a siloxane surfactant.

19. The flexible transparent film as claimed in claim 12, wherein the siloxane surfactant has polar functional groups.

20. The flexible transparent film as claimed in claim 12, wherein the siloxane surfactant is aminosiloxane.

21. The flexible transparent film as claimed in claim 12, wherein the silicone oxide dissolves in an organic solvent with a solid content less than 40%.

22. The flexible transparent film as claimed in claim 12, wherein the polyimide has the structures represented by formula (I), of 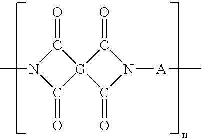
wherein
n is more than 1;
G is cycloalkyl group, heterocycloalkyl group, saturated or unsaturated cycloalkyl group, saturated or unsaturated heterocycloalkyl group, aryl group, heteroaryl group, arylalkyl group, alkylaryl group, heteroalkylaryl group or combinations thereof, and has 3 to 8 carbon atoms; and
A is cycloalkyl group, heterocycloalkyl group, saturated or unsaturated cycloalkyl group, saturated or unsaturated heterocycloalkyl group, aryl group, heteroaryl group, arylalkyl group, alkylaryl group, or heteroalkylaryl group, and has 3 to 8 carbon atoms.

23. The flexible transparent film as claimed in claim 22, wherein G comprises 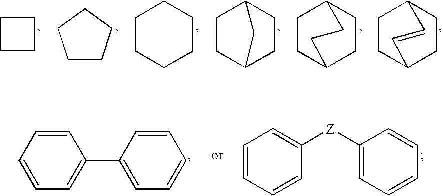
Z is —O—, —CH₂—, —C(CH₃)₂—, —Ar—O—Ar—, Ar—CH₂—Ar—, —Ar—C(CH₃)₂—Ar—, or —Ar—SO₂—Ar—; and Ar is benzene.

24. The flexible transparent film as claimed in claim 22, wherein at least one hydrogen atom bonded to the carbon atom of G is substituted optionally by fluorine atom, halogen atom, cyano group, thioalkyl group, alkyl group, alkoxy group, aryl group, or alkylaryl group.

25. The flexible transparent film as claimed in claim 22, wherein A comprises 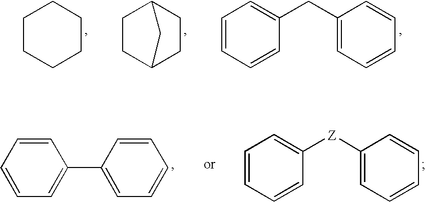
Z comprises —O—, —CH2—, —C(CH3)2—, —Ar—O—Ar—, Ar—CH₂—Ar—, —Ar—C(CH₃)₂—Ar—, or —Ar—SO₂—Ar—; and Ar is berzene.

26. The flexible transparent film as claimed in claim 22, wherein at least one hydrogen atom bonded to the carbon atom of A is substituted optionally by fluorine atom, halogen atom, cyano group, thioalkyl group, alkyl group, alkoxy group, aryl group, or alkylaryl group.

27. The flexible transparent film as claimed in claim 12, wherein the transparency of the film is more than 90%.

28. The flexible transparent film as claimed in claim 12, wherein the glass transition temperature of the film is more than 350° C.

29. The flexible transparent film as claimed in claim 12, wherein the coefficient of thermal expansion of the film is less than 30 ppm/° C.

30. A device, comprising a flexible transparent film, wherein the film comprises silicon oxide and polyimide uniformly mixed, and the weight ratio between silicon oxide and polyimide is not less than 2:8.
